(19) United States
(12) Patent Application Publication
(10) Pub. No.: US 2002/0106021 A1
(43) Pub. Date: Aug. 8, 2002

(54) Method and apparatus for reducing the amount of computation of the video images motion estimation

(75) Inventors: Jar-Ferr Yang, Tainan (TW); Chin-Yun Chen, Hsinchu Hsien (TW); Tzong-Der Wu, Taipei Hsien (TW)

Correspondence Address: DARBY & DARBY P.C., 805 Third Avenue, New York, NY, 10022, US

(73) Assignee: Institute for Information Industry

(21) Appl. No.: 09/801,287

(22) Filed: Mar. 7, 2001

(30) Foreign Application Priority Data
Dec. 18, 2000 (TW) 89127078

(51) Int. Cl. H04N 7/12

(52) U.S. Cl. 375/240.03; 375/240.24; 375/240.16

(57) ABSTRACT

A method and apparatus is used to reduce the unnecessary calculation of the video images motion estimation by identifying the all-zero block or zero-motion vector macroblock in advance. The method of computation reduction stops the motion estimation searching, referring to the condition of the absolute difference and the quantization parameter, and stops the following computation of the Discrete Cosine Transform and quantization. The reference critical value is set according to the motionless residue value of previous frame or the constant critical value to determine the zero-motion vector macroblock in the images.

### BACKGROUND OF THE INVENTION

1. Field of the Invention

The present invention relates to a compression system for digital images and, more particularly, to a method and apparatus for reducing the amount of computation of the digital video images motion estimation.

2. Description of the Prior Art

In many aspects of applications, there is a need for the transmission or storage of video data in the development of information and communication industries. Therefore, the study of digital images compression has become popular. On the whole, digital video images compression eliminates the redundancies in the images to reduce the amount of data. Because the major parts in digital images are predictable, the compression can be accomplished by analyzing the statistical prediction of the digital data. In general, the compression technique is to identify the redundancies in digital images and then eliminate those redundancies from the bit stream.

Take MPEG-2 for example. The first step of compressing a digital image is to apply the Discrete Cosine Transform (DCT) of the image to identify the spatial redundancies in one frame or one field of the digital image. The intra-frame compression reduces the spatial redundancies. The compression ability of MPEG is the flexible quantization of DCT coefficients. In a word, quantization is to reduce the bits in every coefficient characterization. There may be more than 11 bits to characterize the coefficients of DC components, but much fewer bits that characterize the higher coefficients. It can assign different quantization intervals for each macroblock or even larger mcroblock. Following the quantization, lossless data reduction is applied by using Variable Length Coding (VLC) or Run Length Coding (RLC).

Another property of video images is temporal redundancy, which means that, for a given image sequence, the picture content generally varies little from frame to frame.

The calculation of the relative images containing position changes between frames is an important part of inter-frame (between frame) compression and obtains the motion vector. Inter-frame compression works on the uncompressed frames and is lossless. In the motion compensation block, motion vectors are calculated that can best predict the present frame. Since the frames may be different in various manners and only macroblock vectors are allowed, the prediction may not be perfect.

The predicted frame holds the predicted present frame, which has been constructed using the previous frame and the motion vector information. The predicted present picture is then subtracted from the actual present picture and the difference is then output. If there was no motion and no other changes, the present frame could be perfectly predicted and the difference frame output would be zero. When the two frames are not identical but the difference between frames is less, it is still easy to compress.

The calculation of DCT and motion estimation in the compression technique mentioned above is quite complicated. Furthermore, there are many all-zero blocks or zero-motion vector macroblocks generated after coding. The compression technique is not easy to apply on every video transmission or storage apparatus because of those unnecessary calculations.

### OBJECTS OF THE INVETION

According to the above, it is one object of the present invention to provide a method and apparatus for reducing the amount of computation of the video images motion estimation, suitable for identifying the all-zero blocks or zero-motion vector macroblocks in the frames in advance to reduce the number of unnecessary calculations.

It is another object of the present invention to provide a method and apparatus for reducing the amount of computation of the video images motion estimation, suitable for reducing the number of calculations of the following discrete cosine transforms and quantizations.

### SUMMARY OF THE INVENTION

The present invention provides a method and apparatus for reducing the number of computations of the video images motion estimation. According to this present invention, the search s stopped when it fits in with the condition of when the all-zero macroblocks or motion vectors are beneath the reference critical value. If the macroblock fits in with the condition of all-zero macroblock or motion vector being beneath the reference critical value, the macroblock is determined as an all-zero macroblock to reduce the number of calculations in motion estimation.

The present invention also takes account of the relation between motion estimation and the discrete cosine transform and quantization. It can obtain a good result to apply the present invention on low bit rate encoding.

### BRIEF DESCRIPTION OF THE DRAWINGS

FIG. 1 is a schematic view of motion estimation operation of the present invention.

FIG. 2 is a flow chart showing the steps of the present invention for reducing the number of computations of the video images motion estimation.

FIG. 3 is a drawing of dividing a 16 by 16 pixel macroblock into four 8 by 8 pixel blocks.

### DETAILED DESCRIPTION OF THE INVENTION

Embodiment:

In a digital video compression system, the present invention uses a calculation reduction apparatus to reduce the number of computations for motion estimation of a block, which has the highest motion estimation calculation amount. The most obvious difference between video images compression and photographs compression is that searching for the most similar block in the corresponding search area of the frame to the present block, which is to eliminate temporal redundancies of video images, carries out motion estimation. The similarity percentage of blocks is compared to the difference between two blocks. In this embodiment, the difference between two blocks is calculated from the Sum Absolute Difference (SAD).

$$SAD = {\sum }_{i = 0}^{N - 1} {\sum }_{j = 0}^{N - 1} \vert f ( i , j ) - {f}^{′} ( i , j ) \vert$$

In addition to Sum Absolute Difference (SAD), there are still other comparing algorithms to make use of. The amount of SAD is closely related to the best motion vector. In this embodiment, SAD is used to develop the calculation reduction apparatus because when the SAD value is small, the block may be the best match.

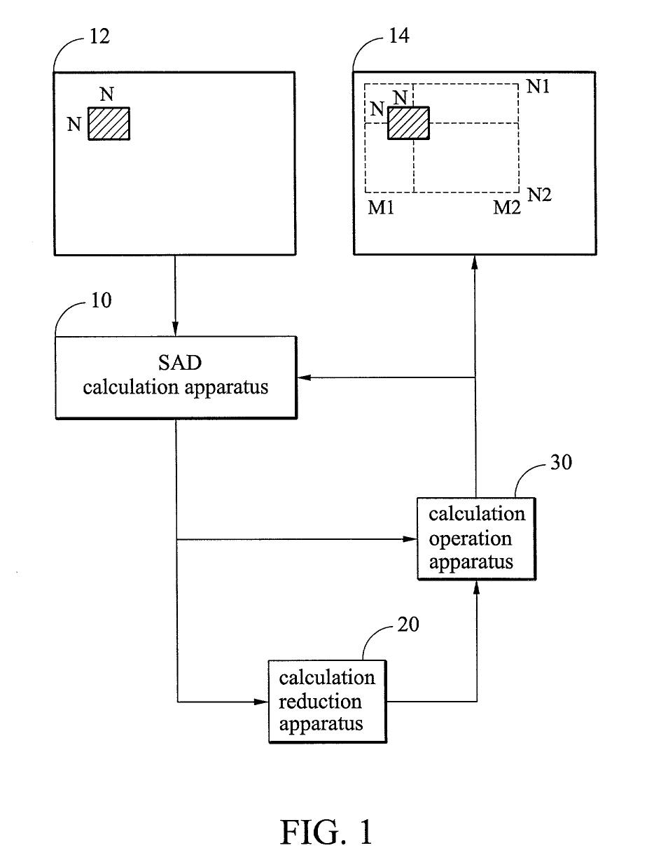

Referring to FIG. 1, the operation of video images motion estimation includes a SAD calculation apparatus 10, a calculation reduction apparatus 20 and a calculation operation apparatus 30. The SAD calculation apparatus 10 calculates the SAD value by comparing one block in the present frame with the block in the corresponding search area of the reference frame 14. Referring to the SAD value calculated from SAD calculation apparatus 10, the calculation reduction apparatus 20 determines to stop searching or to keep searching the next area, and by setting the reference critical value referring to the previous reference frame, the apparatus 20 identifies whether it is a zero-motion vector block. If the result generated from calculation reduction apparatus 20 is to search the next area, the calculation operation apparatus 30 determines the new location by the predetermined algorithm, referring to the SAD value computed by the SAD calculation apparatus 10.

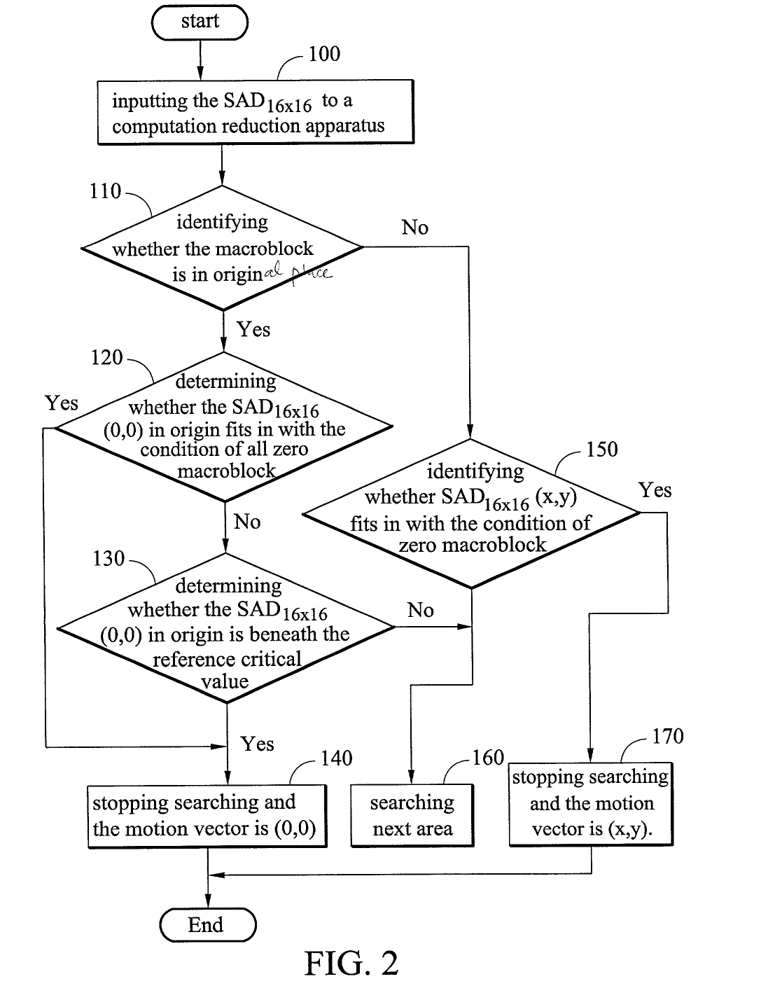

FIG. 2 is a flow chart showing how the calculation reduction apparatus in FIG. 1 works, which comprises the following steps. Input the absolute difference and the SAD_{16×16} computed from previous blocks comparison to the calculation reduction apparatus at 100. Once input is applied, identify whether the macroblock is in its original place at 110. If it is, proceed with step 120, and if is not, proceed with step 150. In step 150, identify whether SAD_{16×16} (0,0) in origin fits in with the condition of the all-zero macroblock at 120. If it does, proceed with step 140, and if is not, proceed with step 130. At step 130, it is to identify whether SAD_{16×14} (0,0) in origin is beneath reference critical value. If it does, proceed with step 140, and if not, proceed with step 160. In step 140, stop searching and the motion vector is (0,0). Identify whether SAD_{16×16} (x,y) fits in with the condition of the all-zero macroblock at 150. If it does, proceed with step 170, and if not, proceed with step 160. At step 160, keep searching the next area. Stop searching at step 170 and the motion vector is (x,y).

Referring to the steps described above, this present invention reduces the number of computations of video image motion estimation by stopping the search when there is an all-zero macroblock or when the data is beneath reference critical value. The condition of all-zero macroblock and the setting of reference critical value are described below in detail.

1.The condition of the all-zero macroblock

After working out the best motion vector by motion estimation, apply the Discrete Cosine Transform and quantization to the residue block that is generated from the difference between the two blocks to further compress the residue block. Whether the coefficient after the Discrete Cosine Transform quantizes into all-zero is related to the value of absolute difference and quantization parameter. For example, when SAD is beneath 20Q (Q: the quantization parameter), an 8 by 8 pixel residue block throughout the Discrete Cosine Transform and quantization is quantized to all zero. This computation is known for reducing the calculating number of the Discrete Cosine Transform and quantization. However, the computation mentioned above could not apply directly on the 16 by 16 pixel macroblock comparison in motion estimation. For further computation reduction in present invention, when the SAD values of four 8 by 8 pixel blocks in one 16 by 16 pixel macroblock are all beneath 20Q, the macroblock is defined as an all-zero macroblock and the following Discrete Cosine Transform and quantization will stop. Whether the search of motion estimation continues depends on the all-zero macroblock condition. When the macroblock fits in with the condition, the search stops.

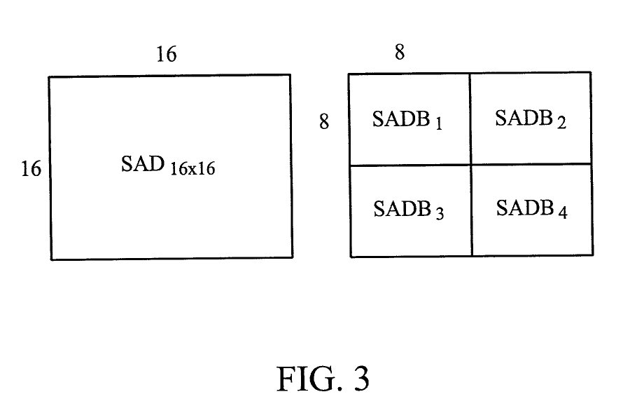

FIG. 3 shows how one 16 by 16 pixel macroblock is divided into four 8 by 8 pixel block and the algorithm is as below:

$$\begin{matrix}{SADB}_{1} = {\sum }_{i = 0}^{7} {\sum }_{j = 0}^{7} \vert f ( i , j ) \vert & {SADB}_{2} = {\sum }_{i = 8}^{15} {\sum }_{j = 0}^{7} \vert f ( i , j ) \vert \\ {SADB}_{3} = {\sum }_{i = 0}^{7} {\sum }_{j = 8}^{15} \vert f ( i , j ) \vert & {SADB}_{4} = {\sum }_{i = 8}^{15} {\sum }_{j = 8}^{15} \vert f ( i , j ) \vert\end{matrix}$$

2.The method of setting the reference critical value

In present invention, for further reduction of the number of computations, identify the zero-motion vector macroblock by the method of setting the reference critical value. The setting of the reference critical value refers to the previous encoded frame. If the macroblock in the corresponding area of previous frame is a zero-motion vector macroblock (i.e. a motionless macroblock), the reference critical value of the present frame is the SAD value added to one constant critical value THR. On the contrary, the macroblock in the corresponding area of previous frame is not a zero-motion vector macroblock, the reference critical value of the present frame is set as the constant critical value THF.

When the macroblock of the present frame is encoding, if its absolute difference and SAD (0,0) in the origin is beneath the reference critical value, the macroblock is determined as a zero-motion vector macroblock and the following search stops. The combination of the reference critical value THR and THF could vary with the quality of the video images or the amount of computation.

The calculation reduction apparatus in present invention includes the condition of all-zero block and the method of setting reference critical values. However, the calculation reduction apparatus could proceed with any known algorithm for rapid search to evaluate the motion estimation, the Discrete Cosine Transform and the Quantization. When the search of motion estimation stops is determined by whether or not the data is quantized to zero. The reduction of the amount of motion estimation calculation proceeds with the determining rule of zero-motion vector macroblock and reduces the calculation of the following Discrete Cosine Transform and quantization. While the invention has been shown and described of the preferred embodiment thereof, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for reducing the amount of computation of the video images motion estimation, comprising:
a difference calculation apparatus used to compute the difference between the block in the present frame and the block in the corresponding search area of the reference frame;
a computation reduction apparatus used to stop searching or keep searching the next area referring to said difference generated from said difference calculation apparatus, and to identify the zero-motion vector macroblock by setting the reference critical value referring the previous frame;
a calculation operation apparatus used to search next area, referring to said difference generated from said difference calculation apparatus, with the predetermined algorithm to determine the searching area.

2. The apparatus as claimed in claim 1, wherein said computation reduction apparatus is an apparatus for Sum Absolute Difference calculation.

3. The apparatus as claimed in claim 1, wherein said difference calculation apparatus is used to identify whether said difference fits in with the condition of all-zero macroblock or is beneath said reference critical value, to determine whether or not the search stops.

4. The apparatus as claimed in claim 3, wherein said condition of the all-zero macroblock is determined when the residue values of four 8 by 8 pixel blocks in one 16 by 16 pixel macroblock all fit in with the condition of said difference and the quantization parameter.

5. The apparatus as claimed in claim 3, wherein said reference critical value is the residue value of the motionless macroblock in previous reference frame added with first constant critical value, and for a non-motionless macroblock in a previous reference frame, wherein said reference critical value is set as a second constant critical value.

6. The apparatus as claimed in claim 3, wherein said difference is the Sum Absolute Difference.

7. The apparatus as claimed in claim 4, wherein said condition between said difference and said quantization parameter is said difference of an 8 by 8 pixel block beneath a certain multiple of said quantization parameter.

8. The apparatus as claimed in claim 5, wherein said first constant critical value and said second constant critical value combine in an exact proportion.

9.The apparatus as claimed in claim 7, wherein said condition between said difference and said quantization parameter is said difference 20 times smaller than that of said quantization parameter.

10. A method that reduces the number of computations of the video images motion estimation, comprising:
(i) inputting the difference generated from previous blocks comparison into a computation reduction apparatus;
(ii) identifying whether the macroblock is in its original place, if it is, go on step (iii), and if not, go on step (vi);
(iii) determining whether the difference of said macroblock in its original place fits in with the condition of the all-zero macroblock, if it does, go on to step (v), and if not, go on to step (iv);
(iv) determining whether or not the difference of said macroblock in its original place is smaller than the reference critical value, if it is, go on to step (v), and if not, go on to step (vii);
(v) stop searching, and then the motion vector is (0,0);
(vi) determining whether or not the difference of said macroblock not in its original place fits in with the condition of the all-zero macroblock, if it does, go on to step (viii), and if not, go on to step (vii);
(vii) searching the next area; and
(viii) stop searching and the motion vector is the coordinates of the point.

11. The method as claimed in claim 10, wherein said condition of all-zero macroblock is determined when the residue values of four 8 by 8 pixel blocks in one 16 by 16 pixel macroblock all fit in with the condition between said difference and the quantization parameter.

12. The method as claimed in claim 10, wherein said reference critical value is the residue value of the motionless macroblock in previous reference frame added with first constant critical value, and for a non-motionless macroblock in previous reference frame, wherein said reference critical value is set as a second constant critical value.

13. The method as claimed in claim 10, wherein said difference is the Sum Absolute Difference.

14. The method as claimed in claim 10, wherein said condition between said difference and said quantization parameter is said difference in an 8 by 8 pixel block beneath a certain multiple of said quantization parameter.

15. The method as claimed in claim 10, wherein said first constant critical value and said second constant critical value combine in exact proportion.

16. The method as claimed in claim 10, wherein said condition between said difference and said quantization parameter is said difference smaller than 20 times that of said quantization parameter.
